(19) United States
(12) Patent Application Publication
(10) Pub. No.: US 2026/0275856 A1
(43) Pub. Date: Sep. 17, 2026

(54) CALIBRATION METHODS FOR OIL BASED MUD IMAGER TOOLS

(71) Applicant: Halliburton Energy Services, Inc., Houston, TX (US)

(72) Inventors: Baris Guner, Houston, TX (US); Ahmed Fouda, Houston, TX (US)

(73) Assignee: Halliburton Energy Services, Inc., Houston, TX (US)

(21) Appl. No.: 19/671,388

(22) Filed: May 8, 2026

Related U.S. Application Data
(63) Continuation of application No. 17/482,892, filed on Sep. 23, 2021, now abandoned.

(51) Int. Cl. E21B 47/002; E21B 47/12; G06T 7/80

(52) U.S. Cl. CPC E21B 47/0025; E21B 47/138; G06T 7/80

(57) ABSTRACT

A method and assembly for calibrating downhole imaging tools includes a calibrator mechanism with a known electromagnetic response, whereby the calibrator mechanism is simultaneously engaged with a plurality of injector electrodes and the at least one return electrode carried on a pad of the downhole imaging tool. A current is injected into the calibrator mechanism by the injector electrodes and the response of the tool is measured. The calibrator mechanism if formed of a homogenous material or fluid so that the electromagnetic response is uniform throughout. The measured electromagnetic response can be compared to the known electromagnetic response and a calibration adjustment can be determined. The calibration adjustment can then be applied to future downhole measurements obtained during an imaging operation.

### CROSS REFERENCE TO RELATED APPLICATIONS

This application is a continuation of U.S. patent application Ser. No. 17/482,892, filed Sep. 23, 2021, which is incorporated by reference in its entirety.

### FIELD OF THE DISCLOSURE

The present disclosure relates generally to downhole imaging tools for use in a wellbore, and more particularly to calibration of downhole imaging tools.

### BACKGROUND

Downhole imaging tools use resistivity images of the formation immediately surrounding a wellbore to provide images in oil-based, synthetic-based and water-based muds in order to visualize and quantify reservoir characteristics and reduce subsurface uncertainty. Such tools transmit high resolution images of the reservoir structure to identify bed dips, open and closed fractures, fault zones, and potential flow barriers with increased accuracy.

Downhole imaging tools typically have a central mandrel on which is mounted a plurality of extendable arms. Each arm carries a pad that can engage a wellbore wall when the arm is extended. Each pad may include a plurality of buttons to inject a current into the formation at desired frequencies and depths. These injected currents return to return electrodes which may also be located on the pads. Although not limited to a particular number, such downhole imaging tools may have, for example, six or eight pads each. During pre-job planning, operators can set the button operating frequencies to enhance the downhole imaging tool range according to local geology, and also define parameters during processing to select the best frequency for given formation responses.

To maximize responses, each pad must be calibrated prior to use. Improper calibration of the downhole imaging tool can result in artifacts in the images. These artifacts are particularly noticeable in low-resistivity or low-contrast formations and can lead to a degraded answer product. Software processing methods can be used to reduce the imaging problems but do not eliminate them. It is desirable to address the root cause of the issue, namely tool calibration, rather than depending on software processing solutions since software processing solutions may not perform as well in a new environment.

### BRIEF DESCRIPTION OF THE DRAWINGS

For a detailed description of the preferred examples of the invention, reference will now be made to the accompanying drawings in which:

FIG. 1 illustrate an example of a well measurement system;

FIG. 2 illustrates an example of a pad of a downhole imaging tool;

FIG. 3 illustrates an example of a circuit model of a downhole imaging tool;

FIG. 4 is a sectional side elevation view of one embodiment of a downhole imaging tool calibration system utilizing a homogenous fluid;

FIG. 5 is a sectional side elevation view of one embodiment of a downhole imaging tool calibration system utilizing a non-porous pad cover;

FIG. 6 is a sectional side elevation view of one embodiment of a downhole imaging tool calibration system utilizing a porous pad cover;

FIG. 7 is a sectional side elevation view of one embodiment of a downhole imaging tool calibration system utilizing two homogenous materials;

FIG. 8 is a sectional side elevation view of one embodiment of a downhole imaging tool calibration system utilizing a circuit;

FIG. 9 is a flowchart of a calibration method for a downhole imaging tool;

FIG. 10 illustrates an example of a graph to determine a calibration function for a downhole imaging tool.

### DETAILED DESCRIPTION

The present disclosure relates generally to a system and method for calibrating resistivity downhole imaging tools used in wellbores to image formations. The proposed system and method may increase the quality of the formation images obtained with oil based mud imagers through uniform calibration of the electrodes of the downhole imaging tool. In one aspect of the disclosure, each electrode carried on a pad of a downhole imaging tool may be placed into contact with a homogenous medium and calibrated based on the electrical properties (i.e. electrical conductivity and permittivity) of the homogenous medium. In another aspect of the disclosure, each electrode carried on a pad of a downhole imaging tool may be placed into contact with at least two homogenous mediums and the electromagnetic response can be utilized to determine a calibration constant or function for the downhole imaging tool. As used herein, “homogenous” means that a material or solution generally has the same electrical properties throughout.

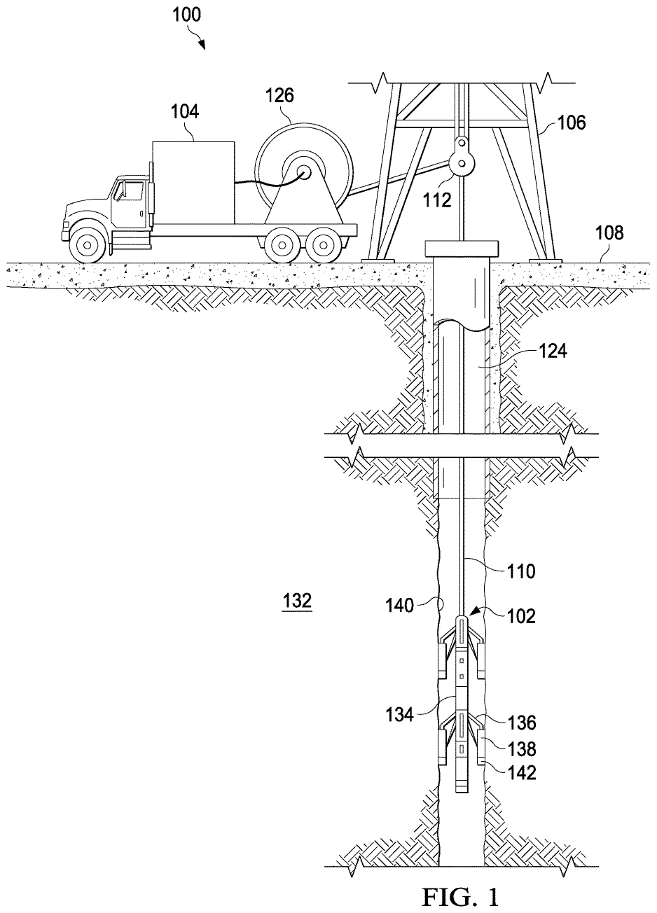

FIG. 1 illustrates a cross-sectional view of a well measurement system 100. As illustrated, well measurement system 100 may comprise downhole imaging tool 102 attached to a vehicle 104. In other embodiments, it should be noted that downhole imaging tool 102 need not be attached to a vehicle 104. In any event, downhole imaging tool 102 may be supported by rig 106 at surface 108. Downhole imaging tool 102 may be tethered to vehicle 104 through conveyance 110. Conveyance 110 may be deployed from a drum 126 carried by vehicle 104. Conveyance 110 may be guided by one or more sheave wheels 112 from drum 126 into a wellbore 124. Conveyance 110 may include any suitable means for providing mechanical conveyance for downhole imaging tool 102, including, but not limited to, wireline, slickline, coiled tubing, pipe, drill pipe, drill string, downhole tractor, or the like. In some examples, conveyance 110 may provide mechanical suspension, as well as electrical connectivity, for downhole imaging tool 102.

Conveyance 110 may comprise, in some instances, a plurality of electrical conductors extending from vehicle 104. The electrical conductors may be used for communicating power and telemetry between vehicle 104 and downhole imaging tool 102.

In any event, downhole imaging tool 102 is shown deployed in a wellbore 124 extending through formation 132. Wellbore 124 may extend generally vertically into the formation 132, however wellbore 124 may extend at an angle through formation 132, such as horizontal and slanted wellbores. While FIG. 1 generally depicts a land-based operation, those skilled in the art may recognize that the principles described herein are equally applicable to subsea operations that employ floating or sea-based platforms and rigs, without departing from the scope of the disclosure.

Downhole imaging tool 102 may generally comprise a main body or central mandrel 134 on which is mounted a plurality of extendable arms 136. FIG. 1 illustrates arms 136 in the extended position although for transport of tool 102 into the wellbore, arms 136 may be retracted towards central mandrel 134. Each arm 136 carries a pad 138 that can engage a wellbore wall 140 when the arm 136 is extended. Finally, each pad 138 may include a plurality of electrodes 142 as described below in more detail.

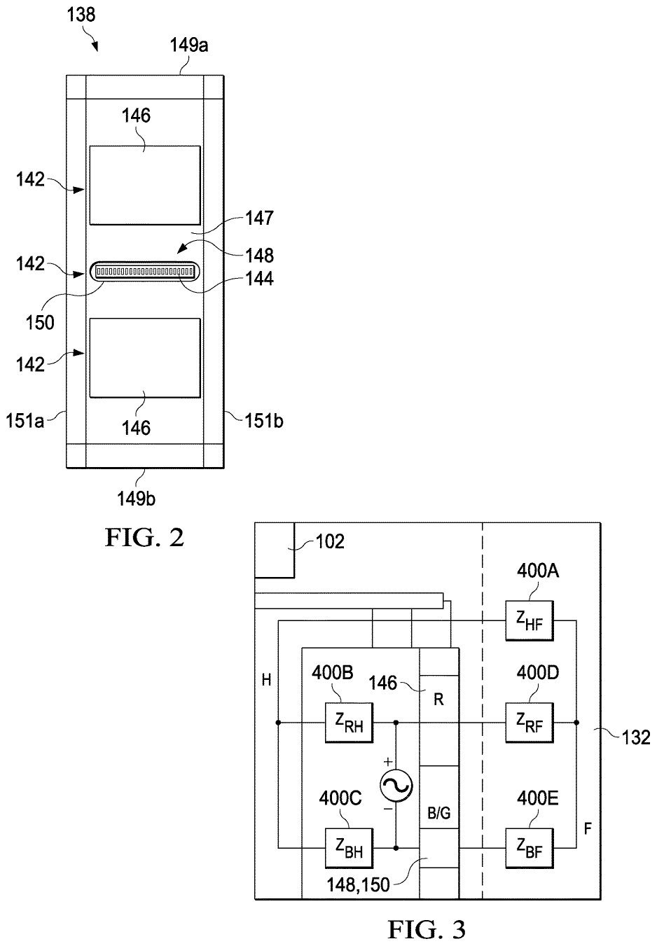

FIG. 2 illustrates an example of pad 138. The plurality of electrodes 142 carried by each pad 138 may include injector electrodes 144, one or more return electrodes 146 or both. In the illustrated embodiment, a plurality of injector electrodes 144 are shown centrally located adjacent a pad surface 147 with return electrodes 146 spaced outwardly from injector electrodes 144. Typically, pad surface 147 is outwardly facing to permit engagement with a wellbore wall 140. Similarly, pad surface 147 may be shaped to generally conform to a wellbore wall 140. As such, pad surface 147 may be elongated from a first end 149a to a second end 149b, and may be arcuate in shape between a first side 151a and a second side 151b. Moreover, as shown, injector electrodes 144 may be individual buttons arranged in an array 148 and hence may also be referred to as buttons 144 herein. In some embodiments, one or more additional electrodes 142 may be positioned between the injector electrodes 144 and the return electrodes 146, such as guard electrode 150 shown in the illustrated embodiment. Likewise, in some embodiments, the array 148 of injector electrodes 144 may extend between the first side 151a and a second side 151b of pad surface 147, with each individual injector electrode 144 generally shaped in a similar fashion, namely elongated in shape between the first end 149a to a second end 149b of pad surface 147 and arcuate in shape between the first side 151a and a second side 151b of pad surface 147.

It should be noted that the plurality of injector electrodes 144 of array 148 may be any suitable electrode and it should be further noted that return electrode 146 may be any suitable electrode. While multiple return electrodes 146 are illustrated, only one return electrode may be utilized. Button array 148 and/or return electrode 146 may be disposed on pad 138 in any suitable order. Likewise, there may be a plurality of button arrays 148. There may be any suitable number of injector electrodes 144 within button array 148 that may produce a desired, predetermined current. Without limitation, the range for a suitable number of injector electrodes 144 within button array 148 may be from about one injector electrode 144 to about one hundred injector electrodes 144. For example, the range for a suitable number of injector electrodes 144 within button array 148 may be from about one injector electrode 144 to about twenty-five injector electrodes 144, from about twenty-five injector electrodes 144 to about fifty injector electrodes 144, from about fifty injector electrodes 144 to about seventy-five injector electrodes 144, or from about seventy-five injector electrodes 144 to about one hundred injector electrodes 144.

In any event, it will be appreciated that when arms 136 are extended from main body 134 (see FIG. 1), arms 136 may place pad 138 in close proximity to wellbore wall 140 so that the arrangement of button arrays 148 and/or return electrode 146 are likewise in close proximity to or otherwise engage wellbore wall 140, it being understood that due to the presence of mud (not shown) along wellbore wall 140, there may be some standoff between pad surface 147 and the wellbore wall 140.

During operations of downhole imaging tool 102, an operator may energize button array 148. A voltage may be applied between each injector electrode 144 and return electrode 146 to induce a current flow therebetween. The voltage may be controlled from vehicle 104 or some other surface location. This may cause an electrical current to be transmitted through button array 148. These currents may travel into formation 132 and may return back to return electrode 146. The amount of current emitted by each injector electrode 144 is inversely proportional to the impedance of the voltage at the injector electrode 144. This impedance may be affected by properties of formation 132 and the mud directly in front of each injector electrode 144. Therefore, current emitted by each injector electrode 144 may be measured and recorded in order to obtain a formation image of the resistivity of formation 132.

Guard electrode(s) 150 may help to focus most of the current produced by button array 148 into formation 132 radially. Guard electrode(s) 150 may be disposed around button array 148. Guard electrodes(s) 150 may have the same potential as button array 148 to help focus most of the current into the formation radially.

Pad 138 may serve to protect button array 148 and return electrodes 146 from the surrounding mud and formation 132. Pad 138 may be made with any suitable material. Without limitation, suitable material may include metals, nonmetals, plastics, ceramics, composites and/or combinations thereof. In examples, pad 138 may be a metal plate. Pad surface 147 may be an insulating material used to fill the remaining portions of pad 134 between electrodes 142. In examples, ceramics may be used as the insulating material to fill the remaining portions of pad 138.

An impedance value may be calculated through the current transmitting between an injector electrode 144 and formation 132 for each injector electrode 144. The voltage between button array 148 and return electrodes 146 may be measured and divided by the transmitted current to produce a value for the impedance measured by each injector electrode 144. Most of the transmitted current may be returned to return electrodes 146 although some portions of it may return through pad 138 and/or downhole imaging tool 102 (referring to FIG. 1).

Turning to FIG. 3, an example of a circuit model that may approximate the downhole imaging tool 102 is provided. This model is only an approximation and provided to illustrate the basing operating principles of downhole imaging tool 102. In this model, H denotes the tool housing (including the mandrel 134, arms 136 and pad 138), F is the formation 132, B/G denotes the button array 148 and guard electrodes 150, and R represents the return electrode(s) 146. Effects of the transmitted current may be approximately characterized by a housing-to-formation impedance value 400A, a return electrode-to-housing impedance value 400B, a return electrode-to-formation impedance value 400C, a button-to-housing impedance value 400D, and a button-to-formation impedance value 400E. Most of the transmitted current is returned to the return electrodes although some portions of it may return through housing and the mandrel. By measuring the voltage between the buttons array 148 and the return electrode(s) 146 and dividing it by the current transmitted through each button or injector electrode 144 of the button array 148, an impedance value can be calculated for each injector electrode 144. This is illustrated in where Z is the injector electrode 144 impedance, VBR is the button to return voltage and IB is the button current.

$$Z = {V}_{BR} / {I}_{B} \qquad Equation 1$$

Impedance calculated in should ideally be equal to the ZBF+ZRF shown in the circuit model. Note that both the ZBF and ZRF have contributions from both mud and the formation. Thus, equivalently it can be written:

$$Z \approx {Z}_{BF} = {Z}_{mud} + {Z}_{F} \qquad Equation 2$$

As a result, measured impedance will have contributions from both the mud and the formation. Assuming imaginary parts of ZF and ZM are mainly capacitive (which is the case in practical situations), and assuming this capacitance is in parallel with the resistive portion, ZBF can also be written as:

$${Z}_{BF} = \frac{1}{( \frac{1}{{R}_{M}} + j ω {C}_{M} )} + \frac{1}{( \frac{1}{{R}_{F}} + j ω {C}_{F} )} \qquad Equation 3$$

where R and C denote the resistance and capacitance, respectively and ω is the angular frequency (i.e. ω=2πf where f is the frequency in Hz.) Subscript M denotes the mud while F denotes the formation. Note that both the mud resistance and mud capacitance increases with standoff and decreases with the effective area of the buttons.

As mentioned above, provides just a basic approximation to the impedance measured by the tool. However, it is useful in illustrating the effect of mud and formation parameters on the measured impedance. For example, it is apparent from this equation that high frequencies are needed to reduce the mud contribution to the measured impedance. can also be used to obtain basic resistivity curves for an imager tool, which curves are fairly accurate in homogeneous formations.

In any event, it will be appreciated that the downhole imaging tool electromagnetic response does not vary linearly with formation resistivity; rather, it is a complex function of formation and mud properties (resistivity and permittivity), as well as the standoff. The dominant effect at low formation resistivities and low frequencies is the standoff effect. Small variations in standoff may cause a large difference in the impedance reading if these raw measurements are used. For the high formation resistivities and high frequencies, formation permittivity starts to have the greatest contribution to the measured impedance. This causes the apparent resistivity curve to decrease after a certain formation resistivity (the resistivity value where this effect starts to show up is formation and tool dependent); thus, it is called the dielectric roll-off.

A basic circuit model was utilized above to demonstrate the operating principles of the resistivity imager tools. Although there exist higher order effects that would not be captured in such a simple model, in most practical cases the circuit model may be used successfully to gain valuable intuition.

In the case where there is no mud (i.e. no standoff), can be modified as follows:

$${Z}_{BF} = \frac{{R}_{F}}{( 1 + j ω {C}_{F} {R}_{F} )} = \frac{{R}_{F} - j ω {{C}_{F} ( {R}_{F} )}^{2}}{( 1 + {( ω {C}_{F} {R}_{F} )}^{2} )} \qquad Equation 4$$

As a result, when formation resistivity is low, the real part of the measured impedance would be approximately equal to R_{F}. This resistance is in turn a function of resistivity. In most cases, this function may be approximated as a simple constant multiplying the formation resistivity, which may be denoted as the tool constant k:

$${R}_{F} \approx k {ρ}_{F} \qquad Equation 5$$

Tool constant is a function of the tool geometry. It is evident from FIG. 2 that different injector electrode geometries would have different tool constants. For example, the currents of the buttons in the middle of the button array would be better focused due to the currents of the buttons on the sides forcing them to flow laterally. As a result, they would be less affected by mud and penetrate more into the formation. On the other hand, buttons on the side would be less focused and their currents would spread more. Thus, they would also be more affected by the rugosity of the downhole. This would result in a “cupping” (also known as the “geometric factor”) effect on the images obtained with an oil-based mud resistivity imager.

Furthermore, in practice, different buttons are connected to different electronic components. In the most basic sense, they may have different trace lengths. They may also be connected to different circuit components such as power amplifiers and multiplexers. If not properly calibrated, this may result in a “striping” effect due to the variations between the individual button electrodes.

Thus, a variety of different factors can impact image quality resulting from a downhole imaging tool 102, including mud parameters, formation parameters, standoff, current frequency, tool geometry, such as electrode placement, internal connections between various electric components, and variations between individual electrodes. Image processing techniques may be used to improve the images in such situations. However, these techniques may not always work well. Furthermore, it is more desirable to address the root cause of the issue. Therefore, proper calibration of the downhole imaging tool 102 is essential in obtaining the equivalent formation resistivity from the measured impedance accurately for each button.

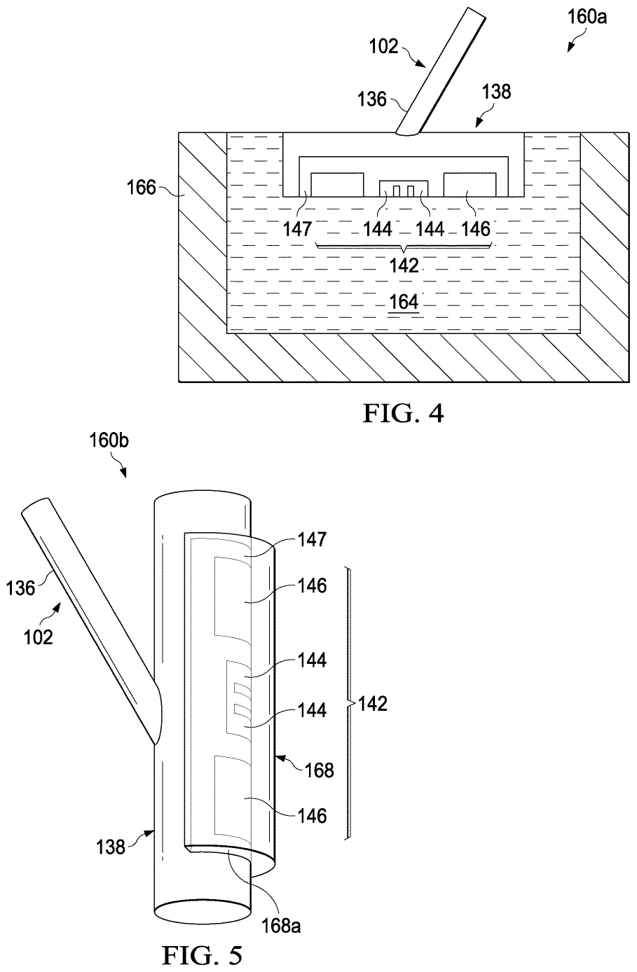

Turning to FIG. 4, one embodiment of a calibrator mechanism 160a is shown. In this embodiment, calibrator mechanism 160a may utilize a homogeneous calibrator fluid 164 of a known or determinable electromagnetic property. In one or more embodiments, the homogeneous calibrator fluid 164 may be conductive. In such case, homogenous fluid 164 may be disposed in a reservoir or container 166 in which the pad 138 of downhole imaging tool 102 may be submerged such that a plurality of injector electrodes 144 and at least one return electrode 146 are in simultaneous electrical communication with the homogenous fluid 164. In other embodiments, at least one injector electrode 144 and at least one return electrode 146 are submerged and in electrical communication with the homogenous fluid 164. In another embodiment, reservoir 166 may be a bladder or other flexible membrane in which the homogenous fluid 164 is sealed, in which case, pad 138 may be placed in contact with the sealed bladder forming container 166 again so that the bladder is in simultaneous contact with a plurality of injector electrodes 144 and at least one return electrode 146 in a manner that forms an electrical path between at least injector electrodes 144 and return electrode(s) 146. In other embodiments, at least one injector electrode 144 and at least one return electrode 146 are engaged by the bladder and in electrical communication with the homogenous fluid 164 therein. Although not limited to a particular type of fluid, in one or more embodiments, homogenous fluid 164 may be brine (i.e. salty water) oil or ethanol. The electromagnetic properties of this fluid may be known or otherwise measurable and selected to be in the operating region of the imager tool. For example, the properties of the fluid may be measured using a vector network analyzer. Then, an electromagnetic simulation may be made that predicts the tool electromagnetic response based on the given electromagnetic properties of the fluid. For example, a numerical electromagnetic solver that utilizes the Finite Element Method (FEM) Finite Difference Time Domain Method (FDTD) or the Method of Moments (MoM) may be used for simulating the tool electromagnetic response. These solvers may model the tool and fluid geometry in all three dimensions (i.e. 3D) or a symmetry in the geometry may be used to simplify the geometry to 2D or 1D. In most cases, the symmetry assumptions would be approximate; in those cases the loss in accuracy may be traded off for the ease of simulation and the reduced computation time. As shown, the surface 147 of pad 138 may be immersed in homogenous fluid 164 such that the homogenous fluid 164 provides a continuous current path between the plurality of button electrodes 144 and the one or more return electrode(s) 146. The complex tool response may be measured. Once the electromagnetic response is measured, calibration function may be calculated using a ratio of the known response to the measured responses as shown in.

$$CF ( b\_i , f\_j ) = ( I\_MOD ( b\_i , f\_j ) ) / ( I\_MEAS ( b\_i , f\_j ) ) \qquad Equation 6$$

In this equation, CF(bᵢ, ƒᵢ) is the calibration function for the ith button at the jth frequency. Similarly, I_{MOD}(bᵢ, ƒᵢ) is the modeled electromagnetic response and the I_{MEAS}(bᵢ, ƒᵢ) is the measured or actual electromagnetic response, again for the ith button at the jth frequency. This calibration function may be stored and the measured responses from the tool may be multiplied by the calibration function during an actual logging operation as previously mentioned.

With reference to FIG. 5, another embodiment of calibrator mechanism 160 is shown as calibrator mechanism 160b, where calibrator mechanism 160b includes a calibrator cover 168 formed of a non-porous material that conforms to the surface 147 of pad 138. Calibrator cover 168 need not cover the entire surface 147 of pad 138 so long as the electrodes 144, 146, 150 of pad 138 are covered in a manner that forms an electrical path between at least injector electrodes 144 and return electrode(s) 146. The calibrator cover 168 may be manufactured out of materials such as polyether ether ketone (PEEK), ceramic, polytetrafluoroethylene (PTFE) or other composite materials. In most cases, electrical properties of such materials are well documented by the manufacturers of the materials, but it is also possible to make measurements of the electrical properties of these materials, for example using a vector network analyzer (VNA). To ensure electrical contact between the calibrator cover 168 and the pad 138, an electrically conductive sealant may be applied to the calibrator cover's surface that will be in contact with pad 138. As was the case with the calibrator fluid 164 of FIG. 4, an electromagnetic simulation software may be used to model the tool's electromagnetic response with the calibrator cover 168 mounted on pad 138. Then, using the actual measurements made by the tool and the modeled electromagnetic response, a calibration function may be calculated. Again, as was the case with the calibrator fluid 164, Equation 6 represents one way to calculate a calibration function for this case. In one or more embodiments, cover 168 may be formed of a rigid or solid material, in which case, cover 168 may be shaped to engage pad 138 as described herein. As such, cover 168 may include an arcuate inner face 168a. In other embodiments, cover 168 may be a flexible material. For example, cover 168 may be a flexible, sealed bladder filled with a homogenous fluid as described above.

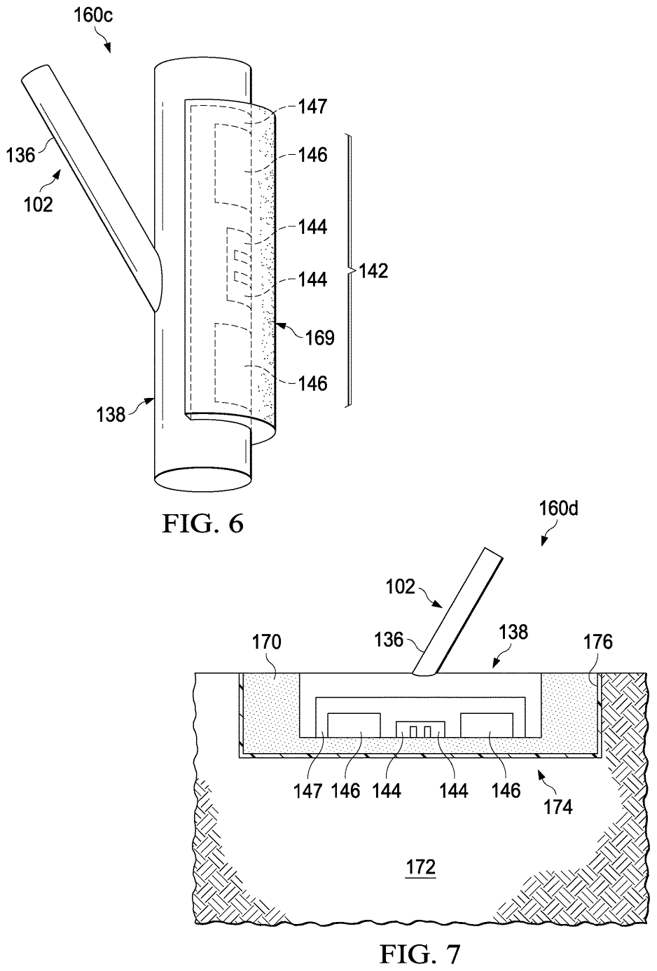

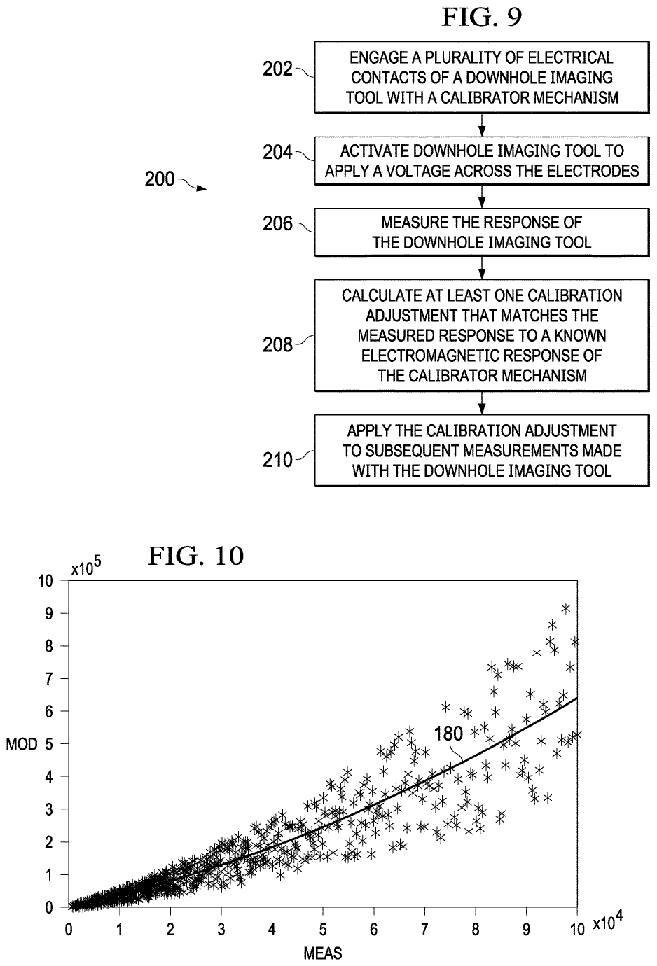

With reference to FIG. 6, another embodiment of calibrator mechanism 160 is shown as calibrator mechanism 160c, where calibrator mechanism 160c includes a calibrator cover 169 formed of a porous material disposed adjacent at least the electrodes 144, 146 of pad 138 in a manner that forms an electrical path between the injector electrodes 144 and at least one return electrode(s) 146. The calibrator cover 169 may be manufactured out of porous materials. In one embodiment, the porous material is rock or sponge. Likewise, the porous material may be rigid or flexible, such as for example, rigid rock or flexible sponge. As used herein, porous refers to a material with open cells, spaces or holes through which a liquid may pass. In one or more embodiments, this porous material may be saturated with a fluid of known volume and known electrical properties. In one or more embodiments, the fluid may be electrically conductive. In one or more embodiments, the fluid may be homogenous. In one or more embodiments, such fluid may be brine, ethanol or oil. Again, electrical properties of the saturated porous material may be measured through a reference tool. The rest of the process may follow that of FIG. 9 as described below.

With reference to FIG. 7, another embodiment of calibrator mechanism 160 is shown as calibrator mechanism 160d, where calibrator mechanism 160d includes a first electrically conductive calibrator component 170 and a second electrically conductive calibrator component 172. In one or more embodiments, the first and second electrically conductive calibrator components 170, 172 have different mechanical, electrical, geometric or resistive properties. For example, in one embodiment, first and second electrically conductive calibrator components 170, 172 may be formed of the same material and have the same electromagnetic properties. The radial thicknesses of the materials may be varied. In another embodiment, first and second electrically conductive calibrator components 170, 172 may have different electrical resistivities or different conductivities. In this regard, first and second electrically conductive calibrator components 170, 172 may be formed of different conductive materials. In one or more embodiments, the first and second calibrator components 170, 172 are selected to resemble an actual downhole environment. As an example, calibrator component 170 may be composed of an inner material that resembles mud (such as oil) such that the radial thickness of the first component 170 models tool standoff, and the second calibrator component 172 may be composed of an outer material that models the formation (such as the porous material filled with fluid of the previously described embodiments.) In the illustrated embodiment, these two materials are separated by a thin, nonconductive lining 174, such as plastic film or a PVC pipe, to prevent fluid flow between the first and second calibrator components 170, 172. Thus, first calibrator component 170 may be a conductive, homogenous liquid, while second calibrator component 172 may be a porous material infused or otherwise saturated with a conductive, homogenous liquid, which may be the same liquid as the first calibrator component 170 or may be a different liquid. If the second calibrator component 172 is a nonporous or nonpermeable solid, there may not be any need for lining 174.

In one or more embodiments, the first calibrator component 170 is a cylinder and the second calibrator component 172 is a cylinder concentric with and disposed about the first calibrator component 170. The downhole imaging tool 102 may be lowered into the inner cylinder of the first calibrator component 170 similar to the operation of the downhole imaging tool 102 into a wellbore 124. In other cases, the first and second calibrator components 170, 172 may have other shapes.

In FIG. 7, second calibrator component 172 is a porous material shaped to include a recess 176 into which the first calibrator component 170, in the form of a liquid, is disposed. In some embodiments, recess 176 may be cylindrical to simulate the shape of a wellbore. In any case, the properties of the first and second calibrator components 170, 172 may be measured and the electromagnetic response of the downhole imaging tool 102 in such an environment may be modeled to perform the calibration. In one or more embodiments, the lining 174 may be incorporated into the model as well. Because this calibrator mechanism 160d more closely resembles the actual logging environment than other calibrator mechanisms 160 described herein, it may produce a higher accuracy.

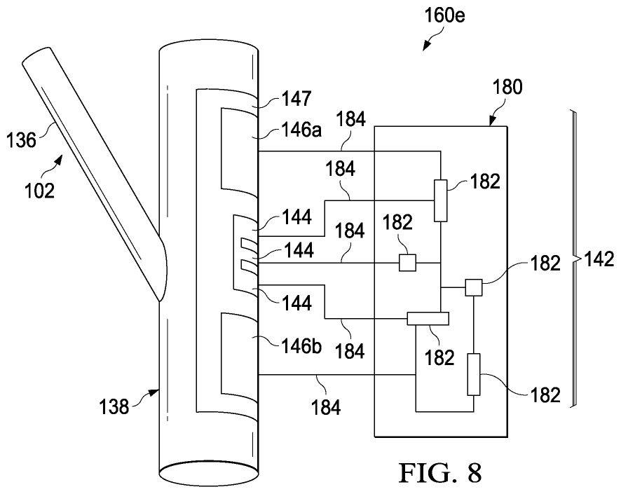

Turning to FIG. 8, another embodiment of calibrator mechanism 160 is shown as calibrator mechanism 160e and is generally formed of at least one circuit 180 composed of circuit components 182 that may be used for calibration. In one or more embodiments, circuit components 182 may be lumped or electrically connected to one another as a sub-circuit that displays a known or select electromagnetic property. In other embodiments, calibrator mechanism 160 may include a plurality of circuits 180, each composed of one or more circuit components 182 that may be lumped as described. In this embodiment, the circuit 180 may be electrically connected with each conductor 142, including injector electrodes 144 and return electrode(s) 146 of the pad 138, as is shown. In this regard, circuit 180 includes a separate pin or probe 184 disposed to engage a separate electrode 142 of the pad 138. For example, pad 138 may include a plurality of injector electrodes 144 in the form of a button, in which case circuit 180 will include a corresponding plurality of pins or probes 184, each disposed to contact a separate or different button 144. To facilitate this contact, each button may have a curvature as it is disposed on the fade 147 of pad 138, and each pin 184 will be shaped to have a corresponding curvature. It will be appreciated that because current from each button may not be identical as it flow out into the formation, the electromagnetic response of each button individually must be determined for the most accurate calibration. For example, buttons in the middle of pad 138 may be more focused than buttons along the edges of a pad 138 or an array 148. The circuit components 182 may include inductors, capacitors and resistors in any arrangement as desired. The electrical properties of these individual components 182 may be known and utilized to model the circuit 180 and an anticipated electromagnetic response of downhole imaging tool 102. At the frequencies of operation of the resistivity imager tools, basic Kirchhoff's laws may be applied to the lumped circuit components 182 with little loss of accuracy to determine the impedance that would be anticipated by downhole imaging tool 102. In other cases, more accurate impedance measurements may be made, again using a reference tool such as a VNA. Then, once the actual measurements are made using downhole imaging tool 102 with the calibrator mechanism 160e connected to conductors 142, a calibration function for pad 138 and/or downhole imaging tool 102 may be calculated using the same procedures as described above.

Although several alternate calibrator mechanisms 160 have already been discussed, the proposed calibration process for each of the calibrator mechanisms 160 is generally the same as represented in FIG. 9 discussed below. Moreover, in each of those cases, calibrator mechanism 160 represents a single calibration environment and calibration was performed on that single point, for example using, allowing a calibration constant to be determined. In such cases, linearity of the operational range was assumed.

FIG. 9 illustrates a calibration method 200 for a downhole imaging tool 102. In a first step 202, a calibrator mechanism 160 (see FIGS. 5-9) is engaged with a plurality of electrodes 142 carried on a pad 138 of downhole imaging tool 102 so that the calibrator mechanism 160 is in electrical contact simultaneously with at least one injector electrode 144 and at least one return electrode 146 carried on pad 138. In other embodiments, calibrator mechanism 160 is in electrical contact with at least a plurality of injector electrodes 144 and at least one return electrode 146 carried on pad 138. Notably, the pad may be separated from the remainder of downhole imaging tool 102 for this step so long as the responses of the electrodes 144 and 146 can be measured. As discussed below, in one or more embodiments, the calibrator mechanism 160 is at least one homogenous material that is in contact with the pad 138 and generally conforms to the shape of the surface of the pad, where the electromagnetic response of the calibrator mechanism 160 is known, predicted, expected or measured as a “model” for subsequent comparison to a measured tool response. In some embodiments, these known responses may be pre-computed and stored for subsequent use in the calculation of calibration adjustments. As used herein, the term “conform” shall refer to any calibrator mechanism 160 that engages a plurality of the electrodes 142 on the surface 147 of a pad 138, regardless of whether the calibrator mechanism 160 is in contact with the entire surface of the pad 138, in a manner that forms an electrical path between at least injector electrodes 144 and return electrode(s) 146. Thus, in this step 202, a pad 138 may be placed in a homogenous fluid or a pad 138 may be placed in contact with a homogeneous, non-porous or porous cover, for example. In an alternative embodiment, a plurality of pins 184 of a calibration circuit may be placed in contact with a corresponding plurality of electrodes 142 of a pad 138. Notably, while it is not necessary to know the actual electrical properties, such as impedance, of the calibrator mechanism 160, it is important that the electromagnetic response of downhole imaging tool 102 to the calibrator mechanism 160 to ensure that the electromagnetic response across all electrodes is consistent.

In any event, with the calibrator mechanism 160 conforming to the surface 147 of a pad 138, in step 204, the downhole imaging tool 102 is activated to apply a voltage across the electrodes 142. Specifically, a current is made to flow from at least one injector electrode 144 to at least one return electrode 146. In some embodiments, current is made to flow from a plurality of injector electrodes 144 to the return electrode(s) 146.

In step 206, the electromagnetic response of the downhole imaging tool 102 is measured and may be recorded. In some embodiments, this may include measuring an electromagnetic response of each individual electrode. In some embodiments, this may include measuring an electromagnetic response of the pad. Moreover, as seen from Equation 3, measured response may be a complex quantity. Thus, in some embodiments, an acquisition system of downhole imaging tool 102 should be capable of recording complex valued measurements. For example, an acquisition system may measure the amplitude and the phase of the tool electromagnetic response.

At step 208, at least one calibration adjustment that matches the measured response to a known electromagnetic response of the calibrator mechanism 160 may be calculated. In one or more embodiments of step 208, this calculation may be based on (i) the measured downhole imaging tool response and a (ii) known response of the calibrator mechanism. This calibration adjustment may be calculated separately for each electrode 142.

In one embodiment of step 208, each electrode 142 is individually adjusted to calibrate downhole imaging tool 102.

In some embodiments, the calibration adjustment may involve multiplication and/or addition operations. Note that determined calibration adjustment may match the modeled electromagnetic response to the measured electromagnetic response, or vice versa. As long as the model and the measurements are consistent, the direction of the matching does not matter. Once the calibration adjustment is obtained, it may be stored and applied to wellbore measurements during or after logging operations to obtain calibrated measurements. Note that the calibration of a single pad has been described in this workflow. In most cases, once a single pad is calibrated, this calibration may be applied to the other pads on a single pad tool or a different tool that has the same design with the calibrated tool with negligible loss in accuracy. However, this is not meant to limit the scope of the disclosure and it is possible to calibrate all the pads of a tool separately and/or to apply calibration to each tool on an individual basis.

In any event, the calibration adjustment may be calibration constant that will make all buttons read the same reference value from the calibrator mechanism 160 or the calibration adjustment may be a calibration function.

With respect to a calibration constant, in one embodiment, a single point calibration may be used by employing a fixed setup with a known electromagnetic response. In this case, calibration function will reduce to a calibration constant for a given button electrode and frequency as given in Equation 6.

It has been found that in some instances, downhole imaging tools may exhibit some nonlinearity in their operational range. As such, calculation of a calibration constant as discussed above is not possible. Thus, in one or more embodiments, to account for such nonlinearities, a multipoint calibration may be used to fit the measured electromagnetic response to the model electromagnetic response such that the calibration adjustment becomes a calibration function. As an example of an extension of the single point calibration to a multipoint calibration, calibrator mechanism 160d of FIG. 7 will be used. Although it may be appreciated that the same method may be applied to any other calibrator structure by changing the electrical properties of the calibrator (by, for example, changing the circuit elements for the calibrator of FIG. 8.)

Downhole imaging tool 102 electromagnetic response is a function of formation and mud properties. As an example, an electromagnetic model of the tool response may include the following environmental parameters: Formation resistivity ρF, formation permittivity εF, mud resistivity ρM, mud permittivity εM and standoff so. A set of measurements may be made with the calibrator mechanism 160 for a variety of combination of values for these parameters. When an adequate number of measurements are performed (which is dependent on the operating characteristics of the specific tool in question and the linearity of its response) a mapping function may be obtained between the measurements and the corresponding modeled electromagnetic responses where the parameters of the mapping function are optimized such that the error between the measurements and the model is minimized (for example, in a least-squares sense.) As mentioned previously, the mapping function may map the measurements to the modeled electromagnetic response or may map the modeled electromagnetic response to the measurements. As long as the model and the measurements are consistent as a result of calibration, this order is not important.

In one example of such a matching process, components of the complex measurement signal may be calibrated separately. These components may be represented either using the absolute value and the phase of the signal or real and imaginary parts of the signal. Calibration of the absolute value of the signal will be described below for illustrative purposes. Once enough measurements corresponding to different environmental parameters are made, a cross-plot of the measurements (x-axis) versus modeled (y-axis) results may be made as shown in FIG. 10, where asterisks show the data points. Then, a calibration function with a certain shape but with unknown parameters may be defined to relate model to the measurements. This function may be a polynomial of a certain order, but it may be possible to use many other forms for the calibration function such as exponential, logarithmic etc. or a combination of these. Again, for illustration purposes, it may be assumed that the relationship between model and the measurements is a quadratic polynomial with unknown coefficients. Then, the coefficient values that best matches the data, for example in a least squares sense, may be selected. This is depicted in Equation 7, where I_{MOD} is the modified model (where original model is mapped using a mapping function, X̅ denotes the parameter vector of the mapping such as the coefficients of the polynomial and double bars denote the norm operation.

$${arg}_{\overline{X}} min ‖ \vert {\tilde{I}}_{MOD} ( \overline{X} ) \vert - \vert {I}_{MEAS} \vert ‖ \qquad Equation 7$$

For the example shown in FIG. 10, line 180 shows the result of such a fit where the quadrature polynomial is selected as 3×10⁻⁵× |I_{MEAS}|²+3.4×|I_{MEAS}|+113.

As before, these mapping parameters may be a function of variables such as the operating frequency of the tool and the button number. In certain implementations, Equation 7 may involve additional regularization terms.

In another embodiment, it may be possible to fit different models to a training dataset (for example, polynomials of different orders) and then select the best model out of these models using a separate test dataset not used in fitting the models to prevent bias in the model selection.

In another embodiment, a complex mapping function for the complex signals may be determined (rather than individual components of the complex signal.)

In another embodiment, input parameters of the forward model may be mapped to some other effective parameter set that best matches the measurements based on the input. That is, in this case, effective parameter set that is inputted to the forward model (\tilde{P}) is obtained using a mapping function (F) applied to the original parameter vector P̅, where parameter vector may consist of parameters such as ρF, εF, ρM, εM and so. This mapping function may be a polynomial of unknown coefficients in examples and the coefficients of the polynomial may be obtained using a least-squares minimization as before.

$$\tilde{P} = F ( \overline{P} ) \qquad Equation 8$$

In a more general version of the above embodiment, more parameters of the forward model may be optimized based on data. These parameters may include parameters based on tool geometry. For example, a factor may modify the button size to account for spreading effects and the value for this factor may be determined based on a best fit to the data as before.

Finally, in step 210, the calibration adjustment is applied to subsequent measurements made with the downhole imaging tool.

Thus, a system for calibrating downhole imaging tools has been described. On one or more embodiments, the system may include a downhole imaging tool having a plurality of injector electrodes and at least one return electrode; and a calibrator mechanism with a known electromagnetic response, the calibrator mechanism disposed to engage all of the plurality of injector electrodes and the at least one return electrode simultaneously. In other embodiments, the system may include a downhole imaging tool having a main body, at least one arm expendably mounted on the main body, with a pad mounted on the extendable arm, and a plurality of injector electrodes and at least one return electrode mounted on a face of the pad; and a calibrator mechanism with an electromagnetic property, the calibrator mechanism disposed to engage all of the plurality of injector electrodes and the at least one return electrode simultaneously, wherein the calibrator mechanism conforms to the face of the pad and is in electrical contact with both the plurality of injector electrodes and the at least one and return electrode.

For any of the foregoing embodiments of a system for calibrating downhole imaging tools, the system may include, any one or more of the following elements, alone or in combination with one another:

The downhole imaging tool comprises a main body, at least one arm expendably mounted on the main body and a pad mounted on the extendable arm, wherein the plurality of injector electrodes and the at least one return electrode are mounted on a face of the pad, wherein the calibrator mechanism conforms to the face of the pad and is in electrical contact with both plurality of injector electrodes and the at least one and return electrode.

The calibrator mechanism is made of at least one rigid, conductive material with an inner face shaped to conform to the face of the pad.

The calibrator mechanism comprises a homogenous material.

The calibrator mechanism comprises a homogenous liquid.

The calibrator mechanism comprises a container in which a homogenous, conductive liquid is disposed, and the pad is at least partially submersed in the liquid so that the liquid provides continuous current path between the plurality of injector electrodes and at least one return electrode.

The calibrator mechanism comprises a porous material shaped to conform to the face of the pad; and an electrically conductive fluid saturating the porous material.

The calibrator mechanism consists of an electrical circuit composed of circuit elements and a plurality of pins, where each pin is electrically connected to a separate one of the plurality of injector electrodes and at least one return electrode.

The calibrator mechanism comprises a first electrically conductive calibrator component and a second electrically conductive calibrator component.

The first electrically conductive calibrator component has a first radial thickness and the second electrically conductive calibrator component has a second radial thickness.

The first and second radial thicknesses may be varied.

The first electrically conductive calibrator component has a first electromagnetic property and the second electrically conductive calibrator component has a second electromagnetic property different than the first electromagnetic property.

The calibrator mechanism comprises a reservoir in which a homogenous, conductive liquid is disposed.

The calibrator mechanism comprises a porous material shaped to conform to the face of the pad; and an electrically conductive fluid saturating the porous material.

The calibrator mechanism comprises of an electrical circuit composed of circuit elements and a plurality of pins, where each pin is electrically connected to a separate one of the plurality of injector electrodes and at least one return electrode.

The calibrator mechanism comprises a cover formed of at least one rigid, conductive, homogenous material with an inner cover face shaped to conform to the face of the pad.

Likewise, a method for calibrating downhole imaging tools has been described. One or more embodiments of the calibration method may include engaging a calibrator mechanism having modeled electromagnetic properties with at least one injector electrode and at least one return electrode of a downhole imaging tool; energizing the downhole imaging tool to propagate a current from the injector electrode to return electrode via the calibrator mechanism; measuring the downhole imaging tool response in the presence of the calibrator mechanism; computing at least one calibration adjustment based on (i) the measured downhole imaging tool response and a (ii) known response of the calibrator mechanism; and applying the calibration adjustment to subsequent measurements made with the downhole imaging tool.

For any of the foregoing embodiments of a method for calibrating downhole imaging tools, the methods may include, any one or more of the following, alone or in combination with one another: Engaging comprises at least partially submerging a pad of the downhole imaging tool in a homogenous liquid.

Measuring comprises recording complex-valued (real and imaginary or amplitude and phase) impedances of the injector electrodes.

Different calibration adjustments are computed for different injector electrodes and frequencies.

The steps of engaging, energizing, and measuring are repeated for multiple calibrator mechanisms with different electromagnetic properties, and thereafter, at least one non-linear relationship is established between recorded and modeled downhole electromagnetic tool responses.

A predicted response is complex-valued impedances computed by modeling the downhole imaging tool response to the calibrator model using the known electromagnetic properties of the calibrator mechanism.

The known response is a 3-D/2-D/1-D computer model, or a circuit model.

The calibration adjustment are functions of complex-valued coefficients computed by taking the ratio of the predicted responses to the recorded responses.

The calibrator mechanism includes at least one solid material with known electrical conductivity and permittivity in the frequency range of tool operation, and the material is molded or carved to conform to the face of the pad.

The calibrator mechanism comprises a container to hold at least one fluid (e.g. brine, oil, ethanol, etc.) with known electrical conductivity and permittivity in the frequency range of tool operation, and the pad is at least partially submersed in the fluid so that the fluid provides continuous current path between the electrodes.

The calibrator mechanism comprises a porous material (e.g. sponge, rock etc.) carved to conform to the face of the pad, the porous material is saturated with known volume of at least one fluid with known electrical conductivity and permittivity in the frequency range of tool operation.

The calibrator mechanism consists of an electrical circuit composed of lumped circuit elements and the surfaces of the electrodes on the pad is connected with conducting pins to this electrical circuit.

The calibrator mechanism comprises at least two materials with different electromagnetic properties, the first material in contact with the tool has properties representatives of downhole mud in the tool operating environment, and the second material has properties representatives of formation.

The thickness of the first material models tool standoff.

Utilizing a first electrically conductive calibrator component having a first electromagnetic properties to perform the steps of engaging, activating and measuring; and thereafter, utilizing a second electrically conductive calibrator component having a second electromagnetic properties different than the first electromagnetic properties and repeating the steps of engaging, activating and measuring.

Utilizing a first electrically conductive calibrator component having a first thickness to perform the steps of engaging, activating and measuring; and thereafter, utilizing a second electrically conductive calibrator component having a second thickness different than the first thickness and repeating the steps of engaging, activating and measuring.

Multiple calibrator mechanisms consist of multiple circuits composed of different lumped circuit element components.

The electromagnetic properties of the calibrator mechanism is measured prior to calibration using an independent (reference) instrument such as a vector network analyzer.

Although the present disclosure and its advantages have been described in detail, it should be understood that various changes, substitutions and alterations can be made herein without departing from the spirit and scope of the disclosure as defined by the following claims.

What is claimed:

1. A system for calibrating downhole imaging tools, the system comprising:
a downhole imaging tool having a plurality of injector electrodes and at least one return electrode;
a first calibrator component with a first known electromagnetic response to perform calibration, the first calibrator component disposed to engage at least one of the plurality of injector electrodes and the at least one return electrode simultaneously for calibrating tool standoff; and
a second calibrator component with a second known electromagnetic response to perform calibration for calibrating formation properties.
thereafter, at least one non-linear relationship is established between measured and known downhole electromagnetic tool responses.

2. The system of claim 1, wherein the downhole imaging tool comprises at least a pad wherein the plurality of injector electrodes and the at least one return electrode are mounted on a face of the pad, wherein at least one of the calibrator components conforms to the face of the pad and is in electrical contact with both plurality of injector electrodes and the at least one and return electrode.

3. The system of claim 2, wherein at least one of the calibrator components is made of at least one solid material with an inner face shaped to conform to the face of the pad.

4. The system of claim 3, wherein at least one of the calibrator components comprises a container in which a homogenous liquid is disposed, and the pad is at least partially submersed in the liquid so that the liquid provides continuous current path between a plurality of injector electrodes and at least one return electrode.

5. The system of claim 4, wherein at least one of the calibrator components comprises a porous material shaped to conform to the face of the pad; and a fluid saturating the porous material.

6. The system of claim 5, wherein at least one of the calibrator components consists of an electrical circuit composed of circuit elements and a plurality of pins, where each pin is electrically connected to a separate one of at least one of the injector electrodes and at least one return electrode.

7. The system of claim 6, wherein the first calibrator component is positioned at a first radial position from the at least one of a plurality of injector electrodes and the second calibrator component is positioned at a second radial position from the at least one of a plurality of injector electrodes.

8. The system of claim 7, wherein at least one of the calibrator components engages all of the plurality of injector electrodes and the at least one return electrode simultaneously.

9. The system of claim 8, wherein the first calibrator component has a first electromagnetic property and the second calibrator component has a second electromagnetic property that may be different than the first electromagnetic property.

10. A system for calibrating downhole imaging tools, the system comprising:
a downhole imaging tool having a pad, and a plurality of injector electrodes and at least one return electrode mounted on a face of the pad;
a first calibrator component with a first electromagnetic property, the calibrator component disposed to engage at least one of the plurality of injector electrodes and the at least one return electrode simultaneously, wherein the calibrator component conforms to the face of the pad and is in electrical contact with both at least one of the plurality of injector electrodes and the at least one return electrode, and wherein the first calibration component calibrates for tool standoff; and
a second calibrator component with a second known electromagnetic response to perform calibration for calibrating formation properties.

11. The system of claim 10, wherein at least one of the calibrator components comprises a reservoir in which a homogenous liquid is disposed.

12. The system of claim 11, wherein at least one of the calibrator components comprises a porous material shaped to conform to the face of the pad; and a fluid saturating the porous material.

13. The system of claim 12, wherein at least one of the calibrator components comprises of an electrical circuit composed of circuit elements and a plurality of pins, where each pin is electrically connected to a separate one of at least one of the injector electrodes and at least one return electrode.

14. The system of claim 13, wherein at least one of the calibrator components comprises a cover formed of at least one solid homogenous material with an inner cover face shaped to conform to the face of the pad.

15. A method for calibrating downhole imaging tools, comprising:
engaging a multi-component calibrator mechanism having known first and second electromagnetic responses with at least one injector electrode and at least one return electrode of a downhole imaging tool, wherein a first calibration component from the multi-component calibrator mechanism calibrates for tool standoff, and wherein a second calibrator component from the multi-component calibrator mechanism calibrates for formation properties;
energizing the downhole imaging tool to propagate a current from the injector electrode to return electrode via the calibrator mechanism;
measuring the downhole imaging tool response in the presence of the calibrator mechanism;
computing at least one calibration adjustment based on (i) the measured downhole imaging tool response and a (ii) known first and second electromagnetic response of the calibrator mechanism;
applying the calibration adjustment to subsequent measurements made with the downhole imaging tool.

16. The method of claim 15, wherein engaging comprises at least partially submerging a pad of the downhole imaging tool in a homogenous liquid.

17. The method of claim 16, wherein measuring comprises recording complex-valued (real and imaginary or amplitude and phase) impedances of the injector electrodes.

18. The method of claim 17, wherein different calibration adjustments are computed for different injector electrodes and frequencies.

19. The method of claim 18, wherein the steps of engaging, energizing, and measuring are repeated for multiple calibrator mechanisms with different electromagnetic responses, and thereafter, at least one non-linear relationship is established between measured and known downhole electromagnetic tool responses.

20. The method of claim 19, wherein the known response is complex-valued impedances computed by modeling the tool response to a calibrator model using the known electromagnetic properties of the calibrator or the electromagnetic response of the calibrator is measured prior to calibration using an independent reference instrument.
